(19) United States
(12) Patent Application Publication
(10) Pub. No.: US 2009/0229130 A1
(43) Pub. Date: Sep. 17, 2009

(54) INTERCHANGEABLE TODDLER UTENSILS UTILIZING NOVEL RETENTION MECHANISMS AND A NOVEL HANDLE

(76) Inventors: SCOTT T. SWIERSKI, Waxhaw, NC (US); Dawn M. Swierski, Waxhaw, NC (US)

Correspondence Address: Clements Bernard PLLC, 1901 Roxborough Road, Suite 300, Charlotte, NC, 28211, US

(21) Appl. No.: 12/401,885

(22) Filed: Mar. 11, 2009

Related U.S. Application Data
(60) Provisional application No. 61/035,554, filed on Mar. 11, 2008.

(51) Int. Cl. A47J 43/28; B26B 27/00

(52) U.S. Cl. 30/123; 30/296.1; 30/323; 30/327

(57) ABSTRACT

The present invention provides interchangeable toddler utensils, such as a fork, spoon, knife, etc., utilizing a plurality of novel retention mechanisms and a novel handle. Advantageously, the toddler utensils of the present invention may be selectively and removably attached to a toddler's wrist, clothing, chair, stroller, etc. when in use or being stored, such that the toddler utensils are not inadvertently dropped on the floor where they are dirtied or lost, for example. It will be readily apparent to those of ordinary skill in the art that a plurality of other toddler items may be used in conjunction with the novel retention mechanisms and/or novel handle of the present invention, including but not limited to a cup, pacifier, artistic implement, etc.

### CROSS-REFERENCE TO RELATED APPLICATION(S)

The present non-provisional patent application/patent claims the benefit of priority of U.S. Provisional Patent Application No. 61/035,554, filed on Mar. 11, 2008, and entitled “TODDLER UTENSILS,” the contents of which are incorporated in full by reference herein.

### FIELD OF THE INVENTION

The present invention relates generally to interchangeable toddler utensils, such as a fork, spoon, knife, etc., utilizing a plurality of novel retention mechanisms and a novel handle. Advantageously, the toddler utensils of the present invention may be selectively and removably attached to a toddler's wrist, clothing, chair, stroller, etc. when in use or being stored, such that the toddler utensils are not inadvertently dropped on the floor where they are dirtied or lost, for example. It will be readily apparent to those of ordinary skill in the art that a plurality of other toddler items may be used in conjunction with the novel retention mechanisms and/or novel handle of the present invention, including but not limited to a cup, pacifier, artistic implement, etc.

### BACKGROUND OF THE INVENTION

Parents are well acquainted with the difficulties associated with getting toddlers to eat their meals. Toddlers are often frustrated using adult utensils, and such utensils may be dangerous for them to use. More commonly, adult and conventional toddler utensils are inadvertently dropped on the floor where they are dirtied or lost, for example. The same is true for cups, pacifiers, artistic implements, etc. Various implements have been developed to address these difficulties, but none with a degree of success resulting in widespread commercial acceptance or use.

For example, U.S. Pat. No. 5,131,151 (Agase et al.), by its own language, discloses a children's sanitary strap to assist in eating and preventing unsanitary conditions by maintaining eating utensils within close proximity of a child's hand. The invention is a strap that couples to the child's wrist, clothing, or high chair while the opposite end of the strap is coupled to an eating utensil. The utensil is used in the customary fashion, however, if the child is unable to hold the utensil at any time causing the utensil to drop, the sanitary strap of the instant invention prevents the utensil from falling to an unclean area or beyond the reach of the child.

U.S. Pat. No. 6,606,768 (Henry et al.), by its own language, discloses a strap device for holding objects held by infants, for preventing the object from falling to the ground if released by the infant. The strap device includes a flexible strap having a first end with a first securing means, a second end with a second securing means, a first attachment means mounted on the flexible strap near the first end, and a second attachment means mounted on the flexible strap near the second end. The attachment means each may be releasably secured to a position on the flexible strap, forming a primary loop for securing the flexible strap to the object or to a support structure. The first securing means preferably is an elastic loop, which may attach the object to the strap device regardless of the object's shape and dimensions, while the second securing means attaches to a support near the infant for his use.

U.S. Patent Application Publication No. 2007/0175408 (Spencer), by its own language, discloses an apparatus and method for providing a multi-functional fabric covered elastic tether. The fabric covered elastic tether includes a tubular fabric member having an inner elastic member disposed within the tubular fabric member, at least one sliding loop connector connected at a selected location to the tubular fabric member, an adjustment clip operably associated with a first end of the tubular fabric member and the inner elastic member so as to form an adjustable loop end portion, an anchor connection clip operably associated with a second end portion of the tubular fabric member and the inner elastic member, and a safety stop connected at a predetermined position along the length of the tubular fabric member between the anchor connection clip and the adjustment clip for restricting the size of the adjustment loop end portion.

U.S. Pat. No. 5,479,708 (Thomas), by its own language, discloses a utensil holder for infants and toddlers that is made up of a generally triangular handle having a hollow gripping area and a utensil-supporting portion at one side of the handle which converges forwardly and terminates in a socket end portion for insertion of a complementary shank end portion of a utensil. In another preferred form, an eating utensil is disposed with its eating surface facing in a direction substantially parallel to the longer dimension of the handle so that when the handle is grasped and held in a palmar, upright position by the infant, the eating surface may face upwardly for placement of food thereon and insertion into the infant's mouth. In the alternative, the utensil may form a permanent part of the supporting portion at one side of the handle but in either form the handle is longer in a direction transverse to the direction of entry of the utensil into the infant's mouth than the longest dimension across the infant's mouth to prevent lodging of the handle therein.

U.S. Patent Application Publication No. 2006/0175228 (Howel et al.), by its own language, discloses a kitchen utensil system including a universal handle and modular heads adapted for quick and easy interchangeable attachment to the handle. The interchangeable heads may include a fork, spoon, spatula, straining ladle, mixer, or any other suitable head. A storage basket is provided for compact and convenient storage of the handle and interchangeable heads, and maintains all of the components in a single compact configuration when placed in a dishwashing machine. The storage basket further functions to keep the heads organized and accessible during use, and includes a cover that doubles to contain drippings.

U.S. Pat. No. 7,354,331 (Sala), by its own language, discloses a set of interactive eating utensils including a first eating utensil, such as a spoon or other piece of cutlery, and a container for containing food. The spoon or other cutlery piece has an embedded magnet that produces a magnetic field. The container is electrically operable and includes an induction coil that is electrically operatively connected to a speaker for producing sound upon the interaction of the magnetic field of the magnet and an electromagnetic field of the induction coil generated upon passing of an electric current through the coil. The container has a moveable portion that moves in response to a predetermined set of conditions, such as failure of the induction coil magnetic field to interact with first eating utensil magnetic field for a predetermined period of time.

What are still needed in the art, however, are improved implements, retention mechanisms, and handles that are not inadvertently dropped on the floor where they are dirtied or lost, for example, and that are easy and safe for toddlers to use, durable, washable, etc.

### BRIEF SUMMARY OF THE INVENTION

In various exemplary embodiments, the present invention provides interchangeable toddler utensils, such as a fork, spoon, knife, etc., utilizing a plurality of novel retention mechanisms and a novel handle. Advantageously, the toddler utensils of the present invention may be selectively and removably attached to a toddler's wrist, clothing, chair, stroller, etc. when in use or being stored, such that the toddler utensils are not inadvertently dropped on the floor where they are dirtied or lost, for example. It will be readily apparent to those of ordinary skill in the art that a plurality of other toddler items may be used in conjunction with the novel retention mechanisms and/or novel handle of the present invention, including but not limited to a cup, pacifier, artistic implement, etc.

In one exemplary embodiment, the present invention provides an interchangeable toddler utensil that is selectively and removably attached to a toddler's wrist, clothing, chair, stroller, etc. when in use or being stored, such that the interchangeable toddler utensil is not inadvertently dropped and/or lost, the interchangeable toddler utensil including: an implement including a stem portion; a retention mechanism configured to selectively and removably receive and retain the stem portion of the implement; a flexible member coupled to the retention mechanism; and a securement mechanism coupled to the flexible member; wherein the securement mechanism is selectively and removably secured to one of a toddler and an article associated with the toddler. Optionally, the implement is one of a fork, a spoon, a knife, a cup, a pacifier, and an artistic implement. Optionally, the stem portion of the implement includes one of a plug, an internally threaded structure, an externally threaded structure, a female connector, a male connector, a suction connector, a magnetic connector, and a rotational connector. Optionally, the retention mechanism includes one of a cap, an internally threaded structure, an externally threaded structure, a female connector, a male connector, a suction connector, a magnetic connector, and a rotational connector. Optionally, the flexible member includes one of a cord and a ribbon. Optionally, the securement mechanism includes one of a closeable band, an elastic band, a clip, a hook-and-loop fastener, a suction fastener, and a magnetic fastener. Optionally, the stem portion of the implement and the retention mechanism are collectively configured to display one or more of a visual indicator and an audio indicator when the stem portion of the implement is one or more received and retained by or removed from the retention mechanism.

In another exemplary embodiment, the present invention provides an interchangeable toddler utensil, including: an implement including a stem portion; a retention mechanism configured to selectively and removably receive and retain the stem portion of the implement; and a handle coupled to the retention mechanism; wherein the handle is disposed along an axis that is substantially perpendicular to an axis along which the stem portion of the implement is disposed. Optionally, the implement is one of a fork, a spoon, a knife, and an artistic implement. Optionally, the stem portion of the implement includes one of a plug, an internally threaded structure, an externally threaded structure, a female connector, a male connector, a suction connector, a magnetic connector, and a rotational connector. Optionally, the retention mechanism includes one of a cap, an internally threaded structure, an externally threaded structure, a female connector, a male connector, a suction connector, a magnetic connector, and a rotational connector. Optionally, the stem portion of the implement and the retention mechanism are collectively configured to display one or more of a visual indicator and an audio indicator when the stem portion of the implement is one or more received and retained by or removed from the retention mechanism.

In a further exemplary embodiment, the present invention provides a kit including an interchangeable toddler utensil, including: an implement including a stem portion; a first retention mechanism configured to selectively and removably receive and retain the stem portion of the implement; a flexible member coupled to the first retention mechanism; a securement mechanism coupled to the flexible member; wherein the securement mechanism is selectively and removably secured to one of a toddler and an article associated with the toddler; a second retention mechanism configured to selectively and removably receive and retain the stem portion of the implement; and a handle coupled to the second retention mechanism; wherein the handle is disposed along an axis that is substantially perpendicular to an axis along which the stem portion of the implement is disposed. Optionally, the implement is one of a fork, a spoon, a knife, a cup, a pacifier, and an artistic implement. Optionally, the stem portion of the implement includes one of a plug, an internally threaded structure, an externally threaded structure, a female connector, a male connector, a suction connector, a magnetic connector, and a rotational connector. Optionally, the first retention mechanism includes one of a cap, an internally threaded structure, an externally threaded structure, a female connector, a male connector, a suction connector, a magnetic connector, and a rotational connector. Optionally, the second retention mechanism includes one of a cap, an internally threaded structure, an externally threaded structure, a female connector, a male connector, a suction connector, a magnetic connector, and a rotational connector. Optionally, the flexible member includes one of a cord and a ribbon. Optionally, the securement mechanism includes one of a closeable band, an elastic band, a clip, a hook-and-loop fastener, a suction fastener, and a magnetic fastener. Optionally, the stem portion of the implement and one or more of the first retention mechanism and the second retention mechanism are collectively configured to display one or more of a visual indicator and an audio indicator when the stem portion of the implement is one or more received and retained by or removed from the one or more of the first retention mechanism and the second retention mechanism.

### BRIEF DESCRIPTION OF THE DRAWINGS

The present invention is illustrated and described herein with reference to the various drawings, in which like reference numbers are used to denote like mechanism components/method steps, as appropriate, and in which:

FIG. 1 is a perspective view illustrating one exemplary embodiment of the interchangeable toddler utensil of the present invention being used by a toddler, with the retention mechanism of the present invention secured to the toddler's wrist;

FIG. 2 is a perspective view illustrating the interchangeable toddler utensil of FIG. 1 in an unassembled state;

FIG. 3 is a perspective view illustrating the interchangeable toddler utensil of FIGS. 1 and 2 in an assembled state;

FIG. 4 is a perspective view illustrating another exemplary embodiment of the retention mechanism of the present invention;

FIG. 5 is a perspective view illustrating another exemplary embodiment of the toddler implement (i.e. a fork instead of a spoon) of the present invention; and

FIG. 6 is a perspective view illustrating another exemplary embodiment of the interchangeable toddler utensil of the present invention, utilizing the handle of the present invention.

### DETAILED DESCRIPTION OF THE INVENTION

In various exemplary embodiments, the present invention provides interchangeable toddler utensils, such as a fork, spoon, knife, etc., utilizing a plurality of novel retention mechanisms and a novel handle. Advantageously, the toddler utensils of the present invention may be selectively and removably attached to a toddler's wrist, clothing, chair, stroller, etc. when in use or being stored, such that the toddler utensils are not inadvertently dropped on the floor where they are dirtied or lost, for example. It will be readily apparent to those of ordinary skill in the art that a plurality of other toddler items may be used in conjunction with the novel retention mechanisms and/or novel handle of the present invention, including but not limited to a cup, pacifier, artistic implement, etc.

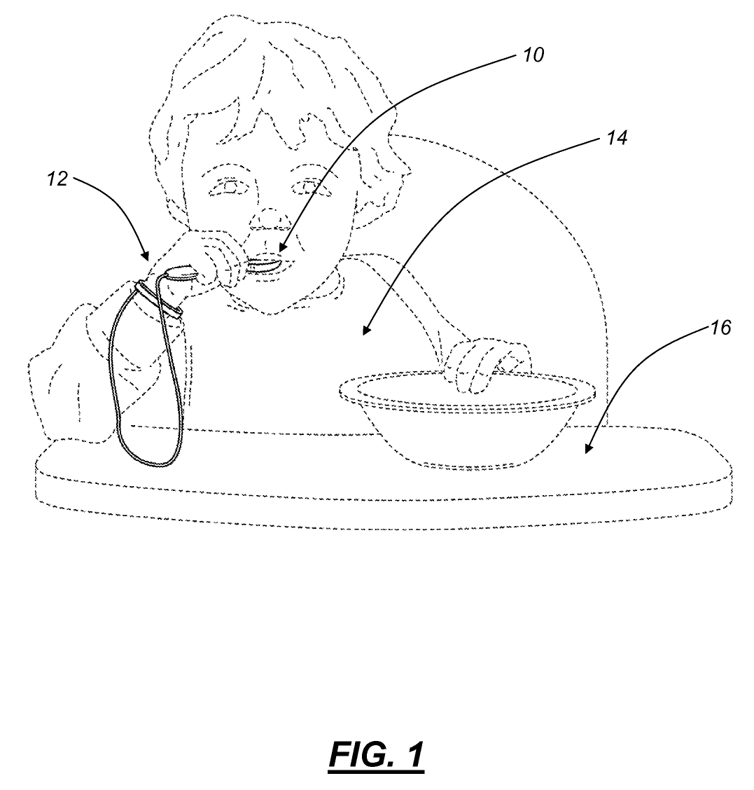

Referring to FIG. 1, in one exemplary embodiment, the present invention provides an interchangeable toddler utensil 10 that is selectively and removably attached to a toddler's wrist 12, clothing 14, chair 16, stroller (not illustrated), etc. when in use or being stored, such that the interchangeable toddler utensil 10 is not inadvertently dropped and/or lost.

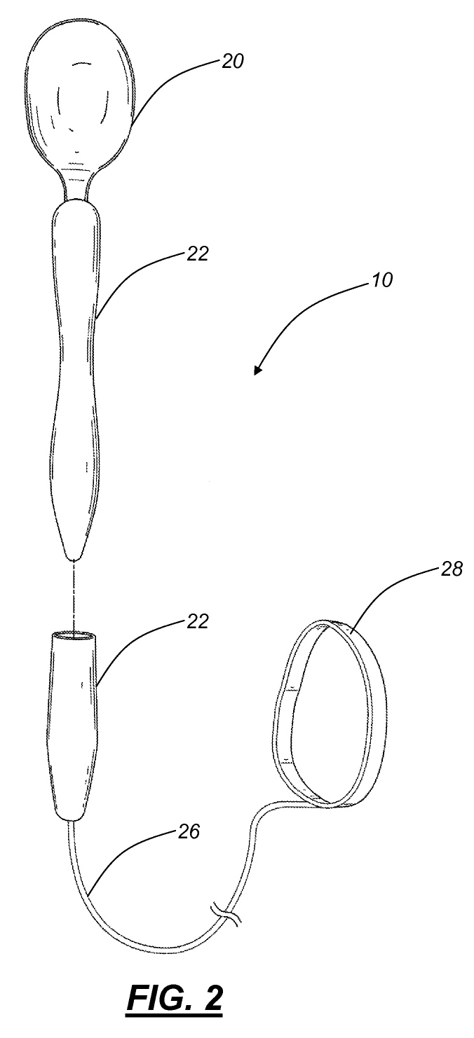

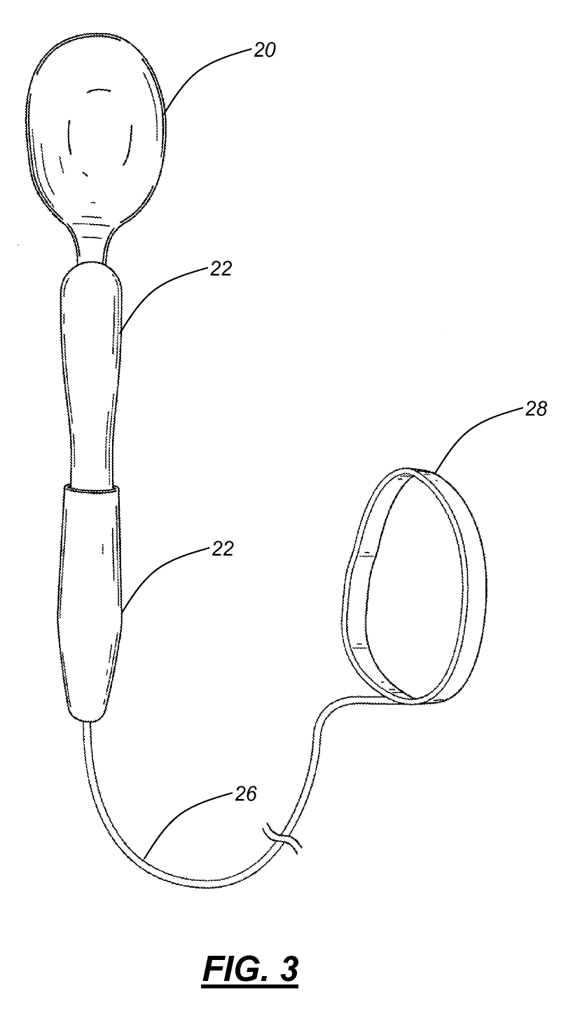

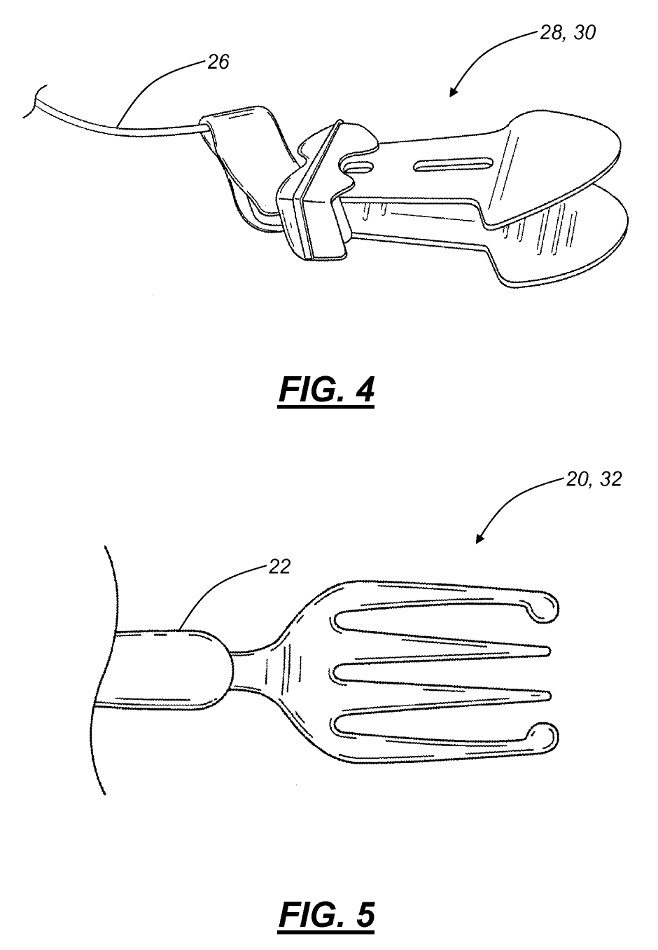

Referring to FIGS. 2 and 3, the interchangeable toddler utensil 10 includes: an implement 20 including a stem portion 22; a retention mechanism 24 configured to selectively and removably receive and retain the stem portion 22 of the implement 20; a flexible member 26 coupled to the retention mechanism 24; and a securement mechanism 28 coupled to the flexible member 26; wherein the securement mechanism 28 is selectively and removably secured to one of a toddler and an article associated with the toddler, as illustrated and described in FIG. 1. Optionally, the implement 20 is one of a fork 32 (FIG. 5), a spoon, a spork, a knife, a cup, a pacifier, and an artistic implement. Optionally, the stem portion 22 of the implement 20 includes one of a plug, an internally threaded structure, an externally threaded structure, a female connector, a male connector, a suction connector, a magnetic connector, and a rotational connector. Optionally, the retention mechanism 24 includes one of a cap, an internally threaded structure, an externally threaded structure, a female connector, a male connector, a suction connector, a magnetic connector, and a rotational connector. Optionally, the flexible member 26 includes one of a cord and a ribbon. Optionally, the securement mechanism 28 includes one of a closeable band, an elastic band, a clip 30 (FIG. 4), a hook-and-loop fastener, a suction fastener, and a magnetic fastener. Optionally, the stem portion 22 of the implement 20 and the retention mechanism 24 are collectively configured to display one or more of a visual indicator and an audio indicator when the stem portion 22 of the implement 20 is one or more received and retained by or removed from the retention mechanism 24.

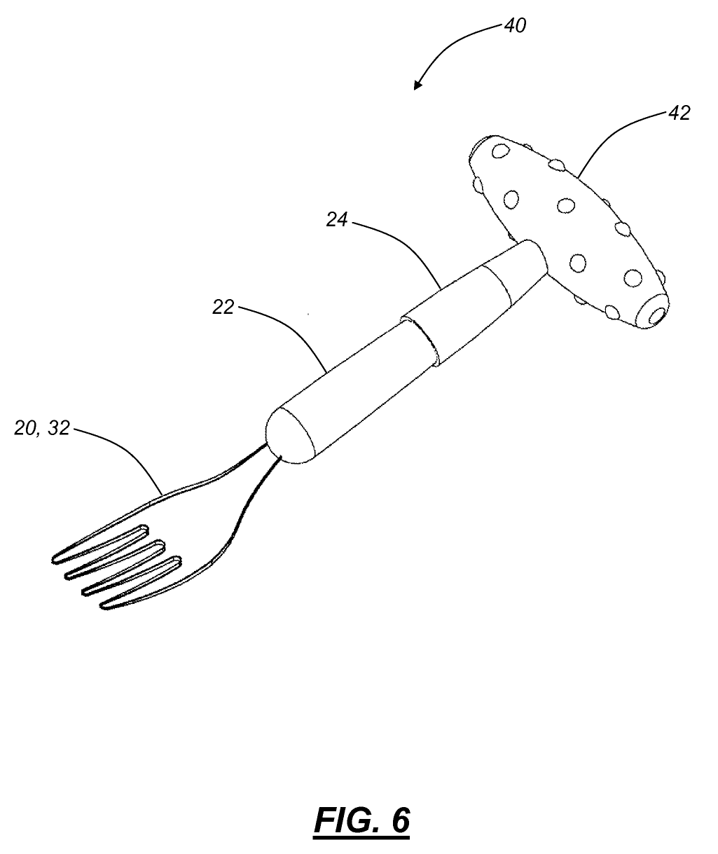

Referring to FIG. 6, in another exemplary embodiment, the present invention provides an interchangeable toddler utensil 40, including: an implement 20 including a stem portion 22; a retention mechanism 24 configured to selectively and removably receive and retain the stem portion 22 of the implement 20; and a handle 42 coupled to the retention mechanism 24; wherein the handle 42 is disposed along an axis that is substantially perpendicular to an axis along which the stem portion 22 of the implement 20 is disposed. Optionally, the implement 20 is one of a fork 32, a spoon, a knife, and an artistic implement. Optionally, the stem portion 22 of the implement 20 includes one of a plug, an internally threaded structure, an externally threaded structure, a female connector, a male connector, a suction connector, a magnetic connector, and a rotational connector. Optionally, the retention mechanism 24 includes one of a cap, an internally threaded structure, an externally threaded structure, a female connector, a male connector, a suction connector, a magnetic connector, and a rotational connector. Optionally, the stem portion 22 of the implement 20 and the retention mechanism 24 are collectively configured to display one or more of a visual indicator and an audio indicator when the stem portion 22 of the implement 20 is one or more received and retained by or removed from the retention mechanism 24.

Referring to FIGS. 1-6, in a further exemplary embodiment, the present invention provides a kit including an interchangeable toddler utensil 10,40, including: an implement 20 including a stem portion 22; a first retention mechanism 24 configured to selectively and removably receive and retain the stem portion 22 of the implement 20; a flexible member 26 coupled to the first retention mechanism 24; a securement mechanism 28 coupled to the flexible member 26; wherein the securement mechanism 28 is selectively and removably secured to one of a toddler and an article associated with the toddler; a second retention mechanism 24 configured to selectively and removably receive and retain the stem portion 22 of the implement 20; and a handle 42 coupled to the second retention mechanism 24; wherein the handle 42 is disposed along an axis that is substantially perpendicular to an axis along which the stem portion 22 of the implement 20 is disposed. Optionally, the implement 20 is one of a fork 32 (FIG. 5), a spoon, a spork, a knife, a cup, a pacifier, and an artistic implement. Optionally, the stem portion 22 of the implement 20 includes one of a plug, an internally threaded structure, an externally threaded structure, a female connector, a male connector, a suction connector, a magnetic connector, and a rotational connector. Optionally, the first retention mechanism 24 includes one of a cap, an internally threaded structure, an externally threaded structure, a female connector, a male connector, a suction connector, a magnetic connector, and a rotational connector. Optionally, the second retention mechanism 24 includes one of a cap, an internally threaded structure, an externally threaded structure, a female connector, a male connector, a suction connector, a magnetic connector, and a rotational connector. Optionally, the flexible member 26 includes one of a cord and a ribbon. Optionally, the securement mechanism 28 includes one of a closeable band, an elastic band, a clip 30 (FIG. 4), a hook-and-loop fastener, a suction fastener, and a magnetic fastener. Optionally, the stem portion 22 of the implement 20 and one or more of the first retention mechanism 24 and the second retention mechanism 24 are collectively configured to display one or more of a visual indicator and an audio indicator when the stem portion 22 of the implement 20 is one or more received and retained by or removed from the one or more of the first retention mechanism 24 and the second retention mechanism 24.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An interchangeable toddler utensil that is selectively and removably attached to a toddler's wrist, clothing, chair, stroller, etc. when in use or being stored, such that the interchangeable toddler utensil is not inadvertently dropped and/or lost, the interchangeable toddler utensil comprising:
an implement comprising a stem portion;
a retention mechanism configured to selectively and removably receive and retain the stem portion of the implement;
a flexible member coupled to the retention mechanism; and
a securement mechanism coupled to the flexible member;
wherein the securement mechanism is selectively and removably secured to one of a toddler and an article associated with the toddler.

2. The interchangeable toddler utensil of claim 1, wherein the implement comprises one of a fork, a spoon, a knife, a cup, a pacifier, and an artistic implement.

3. The interchangeable toddler utensil of claim 1, wherein the stem portion of the implement comprises one of a plug, an internally threaded structure, an externally threaded structure, a female connector, a male connector, a suction connector, a magnetic connector, and a rotational connector.

4. The interchangeable toddler utensil of claim 1, wherein the retention mechanism comprises one of a cap, an internally threaded structure, an externally threaded structure, a female connector, a male connector, a suction connector, a magnetic connector, and a rotational connector.

5. The interchangeable toddler utensil of claim 1, wherein the flexible member comprises one of a cord and a ribbon.

6. The interchangeable toddler utensil of claim 1, wherein the securement mechanism comprises one of a closeable band, an elastic band, a clip, a hook-and-loop fastener, a suction fastener, and a magnetic fastener.

7. The interchangeable toddler utensil of claim 1, wherein the stem portion of the implement and the retention mechanism are collectively configured to display one or more of a visual indicator and an audio indicator when the stem portion of the implement is one or more received and retained by or removed from the retention mechanism.

8. An interchangeable toddler utensil, comprising:
an implement comprising a stem portion;
a retention mechanism configured to selectively and removably receive and retain the stem portion of the implement; and
a handle coupled to the retention mechanism;
wherein the handle is disposed along an axis that is substantially perpendicular to an axis along which the stem portion of the implement is disposed.

9. The interchangeable toddler utensil of claim 8, wherein the implement comprises one of a fork, a spoon, a knife, and an artistic implement.

10. The interchangeable toddler utensil of claim 8, wherein the stem portion of the implement comprises one of a plug, an internally threaded structure, an externally threaded structure, a female connector, a male connector, a suction connector, a magnetic connector, and a rotational connector.

11. The interchangeable toddler utensil of claim 8, wherein the retention mechanism comprises one of a cap, an internally threaded structure, an externally threaded structure, a female connector, a male connector, a suction connector, a magnetic connector, and a rotational connector.

12. The interchangeable toddler utensil of claim 8, wherein the stem portion of the implement and the retention mechanism are collectively configured to display one or more of a visual indicator and an audio indicator when the stem portion of the implement is one or more received and retained by or removed from the retention mechanism.

13. A kit comprising an interchangeable toddler utensil, comprising:
an implement comprising a stem portion;
a first retention mechanism configured to selectively and removably receive and retain the stem portion of the implement;
a flexible member coupled to the first retention mechanism;
a securement mechanism coupled to the flexible member;
wherein the securement mechanism is selectively and removably secured to one of a toddler and an article associated with the toddler;
a second retention mechanism configured to selectively and removably receive and retain the stem portion of the implement; and
a handle coupled to the second retention mechanism;
wherein the handle is disposed along an axis that is substantially perpendicular to an axis along which the stem portion of the implement is disposed.

14. The kit of claim 13, wherein the implement comprises one of a fork, a spoon, a knife, a cup, a pacifier, and an artistic implement.

15. The kit of claim 13, wherein the stem portion of the implement comprises one of a plug, an internally threaded structure, an externally threaded structure, a female connector, a male connector, a suction connector, a magnetic connector, and a rotational connector.

16. The kit of claim 13, wherein the first retention mechanism comprises one of a cap, an internally threaded structure, an externally threaded structure, a female connector, a male connector, a suction connector, a magnetic connector, and a rotational connector.

17. The kit of claim 13, wherein the second retention mechanism comprises one of a cap, an internally threaded structure, an externally threaded structure, a female connector, a male connector, a suction connector, a magnetic connector, and a rotational connector.

18. The kit of claim 13, wherein the flexible member comprises one of a cord and a ribbon.

19. The kit of claim 13, wherein the securement mechanism comprises one of a closeable band, an elastic band, a clip, a hook-and-loop fastener, a suction fastener, and a magnetic fastener.

20. The kit of claim 13, wherein the stem portion of the implement and one or more of the first retention mechanism and the second retention mechanism are collectively configured to display one or more of a visual indicator and an audio indicator when the stem portion of the implement is one or more received and retained by or removed from the one or more of the first retention mechanism and the second retention mechanism.
